(19) United States
(12) Patent Application Publication
(10) Pub. No.: US 2007/0283623 A1
(43) Pub. Date: Dec. 13, 2007

(54) Compartmentalized Hydrogen Fueling System

(75) Inventors: James G. Blencoe, Harriman, TN (US); Michael T. Naney, Knoxville, TN (US); Simon L. Marshall, Oak Ridge, TN (US); Gregory J. Blencoe, Harriman, TN (US)

Correspondence Address: BAKER BOTTS, LLP, 910 LOUISIANA, HOUSTON, TX, 77002-4995, US

(73) Assignee: HYDROGEN DISCOVERIES, INC., HARRIMAN, TN (US)

(21) Appl. No.: 11/758,885

(22) Filed: Jun. 6, 2007

Related U.S. Application Data
(60) Provisional application No. 60/804,201, filed on Jun. 8, 2006.
(60) Provisional application No. 60/821,857, filed on Aug. 9, 2006.
(60) Provisional application No. 60/825,167, filed on Sep. 11, 2006.
(60) Provisional application No. 60/826,660, filed on Sep. 22, 2006.
(60) Provisional application No. 60/918,193, filed on Mar. 15, 2007.
(60) Provisional application No. 60/918,814, filed on Mar. 19, 2007.
(60) Provisional application No. 60/918,767, filed on Mar. 19, 2007.
(60) Provisional application No. 60/910,684, filed on Apr. 9, 2007.
(60) Provisional application No. 60/939,670, filed on May 23, 2007.

(51) Int. Cl. B01J 19/00; B01J 8/08

(52) U.S. Cl. 48/61; 422/232; 422/198

(57) ABSTRACT

A hydrogen fueling system uses solid and/or liquid material(s) to create hydrogen-bearing gas inside one or more fuel compartments. A fuel compartment may be of any size or shape, and its wall(s) may be single- or multi-layered, and of any total thickness. Solid, liquid, and/or gaseous material(s) may flow through one or more entry/exit ports in an individual compartment, or in two or more compartments. If the fueling system contains two or more compartments, material(s) may flow into, or out of, individual compartments in series or in parallel—e.g., sequentially or simultaneously, and hydrogen-bearing gas may flow from one compartment to another. However, solids and liquids do not flow between individual compartments. Hydrogen-bearing gas may be produced inside a compartment by: a reduction in gas pressure, creation of heat from one or more internal or external sources, and/or the occurrence of one or more chemical reactions.

### RELATED PATENT APPLICATIONS

This application claims priority to:
U.S. Provisional Patent Application Ser. No. 60/804,201; filed Jun. 8, 2006; entitled “System, Method and Apparatus for Using Hydrogen as a Fuel,” by James G. Blencoe and Gregory Blencoe;
U.S. Provisional Patent Application Ser. No. 60/821,857; filed Aug. 9, 2006; entitled “Valveless Fueling System for Hydrogen-Powered Vehicles,” by James G. Blencoe, Michael Naney and Gregory Blencoe;
U.S. Provisional Patent Application Ser. No. 60/825,167; filed Sep. 11, 2006; entitled “Mitigating Diffusion Hydrogen Flux Through Solid and Liquid Barrier Materials,” by James G. Blencoe, and Simon Marshall;
U.S. Provisional Patent Application Ser. No. 60/826,660; filed Sep. 22, 2006; entitled “Mitigating Diffusion Hydrogen Flux Through Solid and Liquid Barrier Materials,” by James G. Blencoe, and Simon Marshall;
U.S. Provisional Patent Application Ser. No. 60/918,193; filed Mar. 15, 2007; entitled “Valveless Fueling System for Hydrogen-Powered Vehicles, Equipment and Devices,” by James G. Blencoe, Michael Naney and Gregory Blencoe;
U.S. Provisional Patent Application Ser. No. 60/918,814; filed Mar. 19, 2007; entitled “A Modular, Valveless Magnesium-Hydride Fueling System for Hydrogen-Powered Cars and SUVs,” by James G. Blencoe, Michael Naney and Gregory Blencoe;
U.S. Provisional Patent Application Ser. No. 60/918,767; filed Mar. 19, 2007; entitled “New, Composite Polymeric/Metallic Materials and Designs for Hydrogen Pipelines,” by James G. Blencoe, Simon Marshall and Michael Naney;
U.S. Provisional Patent Application Ser. No. 60/910,684; filed Apr. 9, 2007; entitled “New, Composite Polymeric/Metallic Materials and Designs for Hydrogen Pipelines,” by James G. Blencoe, Simon Marshall and Michael Naney; and
U.S. Provisional Patent Application Ser. No. 60/939,670; filed May 23, 2007; entitled “Valveless Fueling System for Hydrogen-Powered Vehicles, Equipment and Devices,” by James G. Blencoe, Michael Naney and Gregory Blencoe.
   all of which are hereby incorporated by reference herein for all purposes.

### TECHNICAL FIELD

The present disclosure relates generally to hydrogen fueling systems, and, more particularly, to a compartmentalized hydrogen fueling system.

### BACKGROUND

The world is currently in the early stages of a long-term energy crisis. Prices for crude oil have already spiked above $70 per barrel, and gasoline in the U.S. is approaching $3.50 per gallon. These prices are poised to rise further in the future due to a growing supply and demand imbalance, caused primarily by: the rapidly expanding economies of China and India; political instability in many of the oil-producing nations; and the reality that peak global production of conventional crude oil will occur in the next few years, and then embark on a slow, permanent decline.

In addition to crude oil, large amounts of coal and natural gas are used to satisfy the world's energy needs. Like crude oil, coal damages the environment by producing large amounts of nitrous oxide and sulfur dioxide, which are major components of air pollution. In addition, the carbon dioxide released into the atmosphere by combustion of coal and natural gas is widely believed to be a major contributor to global warming.

While world production of conventional crude oil will soon peak, there are sufficient fossil-fuel reserves in the world to satisfy global energy demands for the next 200-300 years. For example, there is a tremendous amount of unconventional crude oil in the Canadian tar sands in Alberta, and in oil shale in Colorado. However, the environment would suffer greatly if our future energy needs were met with these fossil fuels, partly because they would produce significantly higher levels of air pollution and carbon dioxide than conventional crude oil and natural gas.

Clearly, there must be a better way. Is it possible for developed countries to have their energy needs met by fuels that are domestically produced, clean, renewable, and which do not suffer wide price fluctuations? A U.S. energy infrastructure based primarily on hydrogen would accomplish all of these objectives.

However, up to this point, several key technical problems have precluded development of “a hydrogen economy.” One of these is onboard hydrogen storage. As a transportation fuel for light-duty vehicles, hydrogen must be safe, cost competitive with gasoline, and have a driving distance per “fill-up” that meets or exceeds the current 400 mile average. Consumers simply will not accept taking a step backwards in any of these areas.

Hydrogen can be stored in liquid, gaseous, or solid form. Unfortunately, due to the need to achieve and maintain cryogenic temperatures (between approximately −240 and −253° C.), a tremendous amount of energy is consumed in creating and storing liquid hydrogen. In addition, even the best liquid hydrogen storage units cannot prevent slow liquid→vapor conversion, which requires either venting, or “flaring,” of the produced hydrogen gas. In gaseous form, hydrogen's main problem is its low volumetric energy density. For example, the Honda FCX—a fuel cell-powered, prototype car that runs on gaseous hydrogen—contains two large fuel tanks that hold a combined total of 3.75 kilograms of hydrogen gas at 5000 pounds per square inch (psi). Despite the large storage capacity of the two fuel tanks (a total of 41 gallons), the FCX has a driving range of less than 200 miles! Even if onboard hydrogen storage pressure were doubled to 10,000 psi, the driving range of the vehicle would still not come close to acceptable levels, because doubling hydrogen pressure does not double the mass of hydrogen that can be stored onboard.

### SUMMARY

Consequently, there is a need for a hydrogen fueling system that avoids the problems and dangers inherent in storing hydrogen as a liquid, or as a high-pressure (5,000-10,000 psi) gas. According to the teachings of this disclosure, hydrogen may be stored in a solid form to allow it to be handled safely, and to be used as a cost-effective source of hydrogen gas. Storing hydrogen in solid form may be accomplished by combining hydrogen with one or more additional elements to form a hydride. Subsequently, hydrogen gas is released from the hydride through some chemical and/or thermal reaction or interaction.

One benefit of using hydrides as storage media for hydrogen is they have high volumetric energy densities—i.e., they contain large masses of stored hydrogen gas per unit volume. This alleviates the limited driving range problem associated with onboard hydrogen gas stored at 5,000-10,000 psi, because the total mass of hydrogen stored in the fueling system is greatly increased. Since there are many kinds of hydrides, one of the most important considerations is how much hydrogen a particular hydride can hold. However, safety and cost issues must also be considered, and the elements present in the hydride must be abundant and readily available if the hydride is to be used on a global scale. Some elements might seem to make sense at their current price levels (e.g., lithium and boron), but those prices are meaningless if an large increase in demand changes the economics of producing them.

According to the teachings of this disclosure as applied to some of the specific example embodiments herein, a comparatively inexpensive hydrogen gas-producing solid, magnesium hydride (MgH₂), and a hydrogen gas-producing liquid, water (H₂O), may be used to produce hydrogen in controllable amounts for powering a fuel cell, a turbine engine/generator, or a piston-driven internal combustion engine (a turbine engine and/or a piston-driven internal combustion engine may be referred to hereinafter simply as an “internal combustion engine” or “ICE”). Magnesium hydride contains only two elements: magnesium and hydrogen. All other things being equal, that fact makes it inherently cheaper to produce than hydrides containing three or more elements. Also, magnesium is the seventh most abundant element in the Earth's crust. Therefore, despite the fact that not much magnesium is produced in the world today, there is plenty of it available for use in future, hydrogen-based national economies. Finally, as an onboard source of hydrogen gas, magnesium hydride is also much safer than gasoline and gaseous hydrogen stored at 5,000-10,000 psi.

Future, hydrogen-fueled, fuel cell- or ICE-powered light-duty vehicles may use magnesium hydride in the same general way that current light-duty vehicles use gasoline. For example, customers might pump water-slurried magnesium hydride into their vehicles at fueling stations in the same general way that they pump gasoline into their vehicles today. In a car that has a hydrogen fueling system as described hereinafter, the magnesium hydride would react with water, producing hydrogen and water-slurried magnesium hydroxide (commonly known as milk of magnesia). The gaseous hydrogen is then used as a fuel in the fuel cell or ICE. The spent fuel, water-slurried magnesium hydroxide, can be off-loaded at a fueling station and recycled back into magnesium hydride. Future, light-duty vehicles that use magnesium hydride as a source of hydrogen will emit only small amounts of water. Replacement and recycling of spent fuel may be performed at a public fueling station, or at a private, e.g., fleet, fueling station.

A significant benefit of using magnesium hydride as an onboard hydrogen storage medium is that the magnesium may be recycled indefinitely in a closed-loop process. In reality, small losses of magnesium are likely with each re-use. However, it should be possible to re-use each unit mass of magnesium a minimum of several hundred times. Since recycling of magnesium is much less expensive than mining new magnesium, this helps keep fuel costs down. In addition, recycling spent fuel minimizes the initial amount of magnesium that needs to be produced to create a “hydride-based” highway travel and transportation system. Once an initial inventory of magnesium has been created, only small amounts of new magnesium will be needed to replenish what is lost.

Magnesium hydride may also be used as a source of hydrogen gas, according to the teachings of this disclosure, for portable or stationary electric generation wherein the magnesium hydride fuel tank may be coupled to a fuel cell in a lightweight, portable and silent electric generator that has no emissions. This “solid hydrogen-powered” electric generator would have many useful civilian and military applications as a source of electric power. According to the teachings of this disclosure, such an electric generation system may have substantially no moving parts, generate no poisonous emissions (e.g., carbon monoxide), is silent in operation, and may be scaled in size for any power requirement. Thus, for example, a solid-hydrogen/fuel cell electric generator may be used in place of, or as a supplement to, batteries for use in confined areas where venting of toxic emissions is prohibited, and/or in applications that require silent operation and significantly no heat signature, such as clandestine military operations.

According to a specific example embodiment as described in the present disclosure, an apparatus for generating gaseous hydrogen may comprise: a compartment having a first port and a second port; and hydrogen gas-producing material, the hydrogen gas-producing material being located inside of the compartment; wherein the hydrogen gas-producing material releases gaseous hydrogen when a condition thereof is changed, and whereby the second port communicates the gaseous hydrogen outside of the compartment.

According to another specific example embodiment as described in the present disclosure, an apparatus for generating gaseous hydrogen may comprise: a plurality of compartments, each of the plurality of compartments having a first port and a second port; and hydrogen gas-producing material, wherein the hydrogen gas-producing material is located inside of the plurality of compartments; wherein a portion of the hydrogen gas-producing material located in a respective one of the plurality of compartments releases gaseous hydrogen when a condition thereof is changed, and whereby the respective second port communicates the gaseous hydrogen outside of the respective one of the plurality of compartments.

According to yet another specific example embodiment as described in the present disclosure, a power system fueled with hydrogen may comprise: a compartment; a power source fueled by gaseous hydrogen, the power source being either located inside of the compartment or substantially surrounded by the compartment; and hydrogen gas-producing material, the hydrogen gas-producing material being located inside of the compartment; wherein the hydrogen gas-producing material releases gaseous hydrogen to the power source when a condition thereof is changed.

### BRIEF DESCRIPTION OF THE DRAWINGS

A more complete understanding of the present disclosure thereof may be acquired by referring to the following description taken in conjunction with the accompanying drawings, wherein:

FIGS. 1 and 2 illustrate schematic diagrams of side and sectional views of a single fuel compartment that stores hydrogen-bearing gas, one or more of a hydrogen gas-producing solid and a hydrogen gas-producing liquid, according to specific example embodiments of this disclosure;

FIG. 3 illustrates schematic diagrams of various views of a compartment having ports for solids, liquids and/or gases entering and/or exiting the compartment, and compartment heaters for heating the fresh fuel contained therein, according to specific example embodiments of this disclosure;

FIG. 4 illustrates a schematic diagram of a plurality of fuel compartments, comprising a hydrogen fuel tank (see schematic 3-D view in FIG. 5), according to another specific example embodiment of this disclosure;

FIG. 5 illustrates a schematic view of a hydrogen fuel tank having a plurality of fuel compartments, according to specific example embodiments of this disclosure;

FIG. 6 illustrates a schematic diagram of a prior technology hydrogen fuel cell-powered vehicle chassis;

FIG. 7 illustrates a schematic diagram of a hydrogen fuel cell-powered vehicle chassis, according to a specific example embodiment of this disclosure;

FIG. 8 illustrates a schematic diagram of a hydrogen fuel panel, according to a specific example embodiment of this disclosure;

FIG. 9 illustrates schematic diagrams of various views of a gas cap for hydrogen powered vehicles, according to a specific example embodiment of this disclosure;

FIGS. 10 and 11 illustrate schematic diagrams for a first-time use of a power source after initial fueling, or refueling, of a one-compartment, hydrogen-fueled power system, according to specific example embodiments of this disclosure;

FIGS. 12 and 13 illustrate schematic diagrams for a restart of the power source in a one-compartment, hydrogen-fueled power system, according to specific example embodiments of this disclosure;

FIGS. 14 and 15 illustrate schematic diagrams of the one-compartment, hydrogen-fueled power system when fresh fuel runs out, according to specific example embodiments of this disclosure;

FIG. 16 illustrates a schematic diagram of a one-compartment, hydrogen-fueled power system further comprising a gas permeable membrane or gas porous separator, according to another specific example embodiment of this disclosure;

FIGS. 17 and 18 illustrate a schematic diagram of a one-compartment, hydrogen-fueled power system having a solenoid valve, according to still another specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of specific example embodiments are schematically illustrated. Like elements in the drawings will be represented by like numbers, and similar elements will be represented by like numbers with a different lower case letter suffix.

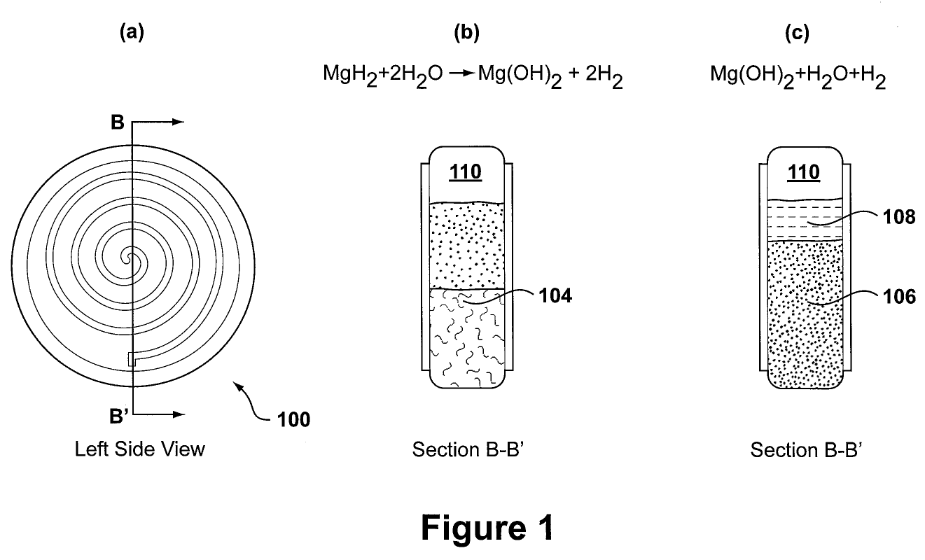

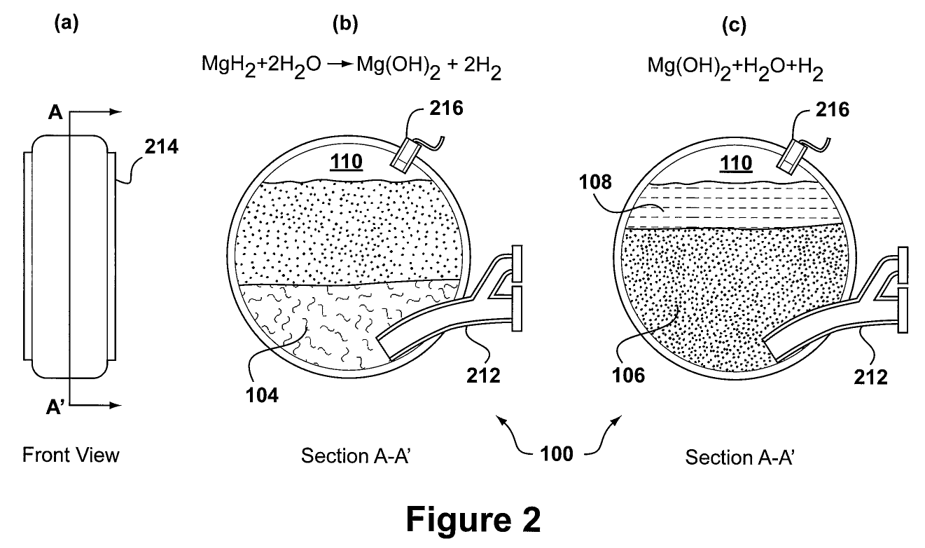

Referring to FIGS. 1 and 2, depicted are schematic diagrams of side and sectional views of a single fuel compartment that stores hydrogen-bearing gas, one or more of a hydrogen gas-producing solid and a hydrogen gas-producing liquid (hereinafter, often referred to generally as “fresh fuel”), according to a specific example embodiment of this disclosure. The fuel compartment, generally represented by the numeral 100, may be of any size or shape; however, with increasing internal gas pressure, increasingly rounded internal morphologies—specially spherical and cylindrical forms, which are the strongest structures for storing compressed gas—may be preferred. In addition, the wall(s) of the fuel compartment 100 may be of any total thickness sufficient to contain the expected pressures therein, may be composed of any suitable material(s), and may be single- or multi-layered as disclosed more fully hereinbelow. If the wall(s) of the fuel compartment 100 is/are single-layered, the wall(s) may be composed of a polymer, a metal or a metal alloy.

The wall(s) of the fuel compartment 100 may be multi-layered to lower the overall weight of the compartment, and/or to decrease the overall rate of diffusive hydrogen flux from the interior(s) of the compartment(s) to the exterior(s) of the compartment(s). Thus, these wall(s) may be composed of either: (i) multiple layers/interlayers of one or more types of polymers; or (ii) one or more layers/interlayers of one or more types of polymers, and one or more layers/interlayers of one or more metals or metal alloys through which hydrogen permeates at a rate slower than that observed for the layers/interlayers of the polymer(s).

The structure comprising the walls of the fuel compartment(s) 100 follow from two strategies for effective hydrogen containment. (1) A multi-layered barrier (hydrogen permeation-blocking) material composed of one or more materials will often have a lower overall hydrogen permeation rate due to a phenomenon known as “contact resistance,” a term that refers to a slowing of the overall rate of gas permeation at the boundaries between the layers/interlayers of a composite material. It is hypothesized that hydrogen diffusive flux at such boundaries is slowed by the microstructural discontinuities that occur at the interface between each layer in the composite material, even when all of the layers are composed of the same solid material. (2) A multi-layered barrier material consisting of one or more layers of one or more polymers, and one or more layers of one or more metals or metal alloys with low hydrogen permeability, will typically have a lower overall hydrogen permeation rate—compared to a single or multi-layered barrier material that does not contain one or more layers of such metal(s) or metal alloy(s)—due not only to the superior performance of the metal(s) or metal alloy(s) in slowing diffusive hydrogen flux, but also to possible enhanced contact resistance that results from the differences between the atomic states of hydrogen in polymeric and metallic materials. In the former, dissolved hydrogen exists in the diatomic state, whereas in metals and metal alloys, diatomic hydrogen splits into individual hydrogen atoms upon its dissolution in the metal or metal alloy. These different mechanisms of dissolution can lead to enhanced contact resistance at the boundaries between contiguous polymeric and metallic layers in a composite structure because, in addition to encountering microstructural discontinuities at each sharp, polymer/metal interface, hydrogen is also forced to switch atomic states in passing from the polymer into the metal/metal alloy and vice versa.

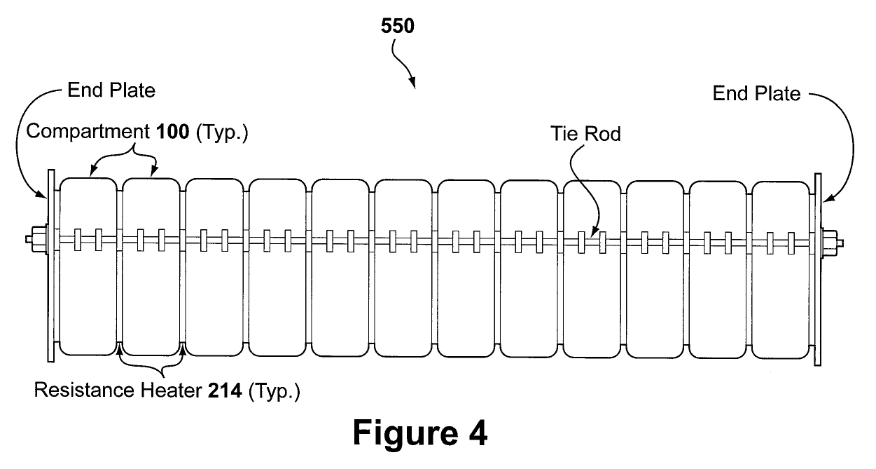

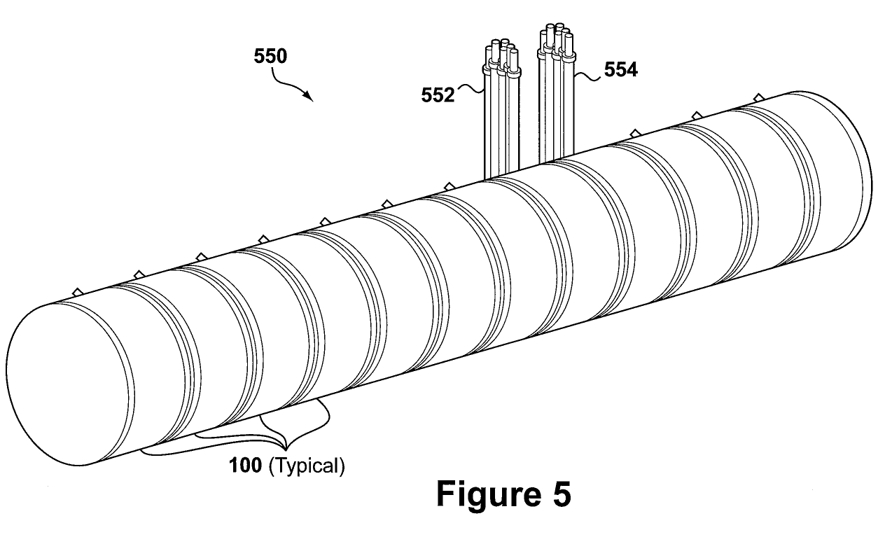

The fresh fuel, generally represented by the numeral 104, inside the compartment 100 used in a fueling system may release/form hydrogen-bearing gas by: (i) a reduction in gas pressure inside the compartment, (ii) creation of heat from one or more internal or external sources, and/or (iii) the occurrence of one or more chemical reactions involving one or more chemical phases or species. The hydrogen fueling system, according to teachings of this disclosure, may be comprised of a plurality of compartments 100 (see FIGS. 4 and 5). In the example shown in FIGS. 1(b) and 2(b) of a chemical reaction between magnesium hydride (MgH₂) and water (H₂O), these two phases (compounds) are chemically combined to produce magnesium hydroxide (Mg(OH)₂) and hydrogen (H₂). The compounds, for this specific example, remaining in the chamber 100 after this chemical reaction comprise magnesium hydroxide 106 (Mg(OH)₂), water 108 (H₂O) and hydrogen 110 (H₂), as shown in FIGS. 1(c) and 2(c).

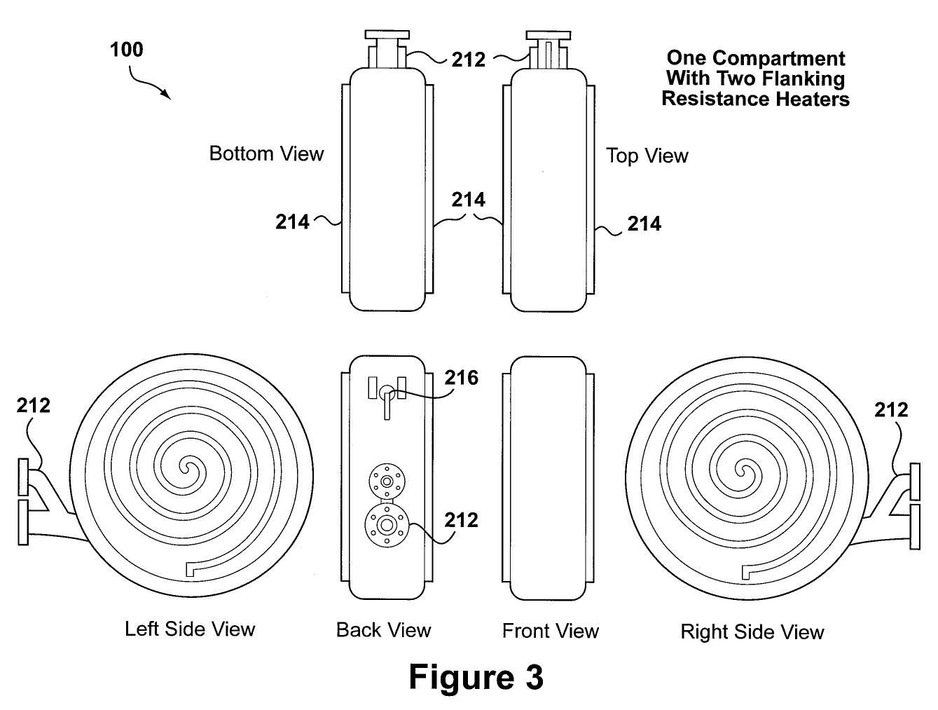

Referring now to FIG. 3, depicted are schematic diagrams of various views of a compartment having ports 212 and 216 for solids, liquids and/or gases entering and/or exiting the compartment, and compartment heaters 214 for heating the fresh fuel contained therein, according to a specific example embodiment of this disclosure. Each compartment 100 in the fueling system may contain one or more material entry/exit ports (“penetrations”) 212. The material(s) that enter/exit the compartment 100 may be in a solid, liquid, or vapor (gaseous) state. According to the teachings of this disclosure, material(s) may flow into, or out of, an individual compartment 100, or into/out of two or more compartments 100. Access to each compartment 100 is gained through the material entry/exit port(s) 212 in the compartment 100. If the fueling system contains two or more compartments 100, material(s) may flow into, or out of, individual compartments 100 in series or in parallel—e.g., sequentially or simultaneously. Material transfer to and from individual compartments 100 may occur, for example, through hollow or partially open connectors or cylinders (e.g., tubes). In some of the specific example embodiments disclosed herein, one or more tubes, that are designed, fabricated and/or manufactured for hydrogen service, may be used to transfer material(s) to, and/or from, one or more compartments 100 in the fueling system.

Referring now to FIG. 4, depicted is a schematic diagram of a plurality of fuel compartments, according to another specific example embodiment of the present disclosure. The fueling system may be comprised of two or more compartments 100, wherein the total inventory of fresh fuel 104 may be divided into two or more discrete, semi-isolated masses. This facilitates incremental production of hydrogen gas inside the fueling system by either: (i) causing part of the fresh fuel in one or more compartments to form hydrogen gas plus a solid and/or liquid residue (hereinafter, usually referred to as “spent fuel”) that is no longer suitable for creating additional hydrogen-bearing gas; or (ii) causing all, or nearly all, of the fresh fuel in one or more compartments to form hydrogen-bearing gas plus spent fuel.

Creating discrete masses of fresh fuel inside the fueling system also facilitates segregation of fresh and spent fuel, because all, or nearly all, fresh fuel in one or more of the compartments 100 can be transformed to hydrogen-bearing gas plus spent fuel, while fresh fuel in one or more other compartments 100 is not transformed to hydrogen-bearing gas plus spent fuel. These capabilities, in turn, enable partial refueling of a multi-compartment fueling system (e.g., refueling on a compartment-by-compartment basis), and serial consumption of small amounts of energy (e.g., battery- or super capacitor-supplied electricity) and material (e.g., water) to produce incremental masses of hydrogen-bearing gas onboard, for example but not limited to, a vehicle.

Hydrogen-bearing gas may flow from one compartment 100 to another. However, solids and liquids do not flow between individual compartments 100. Indeed, the specific example embodiments of the hydrogen fueling system that comprise two or more compartments 100 are designed to prevent this from happening. On the other hand, solids and/or liquids do flow into and out of compartments, and may flow into/out of other reservoirs (not shown) that are either internal to, or external to, the hydrogen fueling system. Generally, the other reservoirs (not shown) are designed to temporarily store one or more solids, liquids, and/or gases prior to, or after, transfer to, or from, one or more compartments 100 in the fueling system. Examples include but are not limited to: gaseous hydrogen, water, solid hydride, and spent fuel storage tanks at a fueling station; and a water storage tank that is a functioning part of the hydrogen fueling system. Solid, liquid, and/or gas may also flow into the fueling system from an external source (not shown) where the solid, liquid, and/or gas is being produced continuously, or with considerable regularity. This external source (not shown) might be, for example but not limited to, a water reservoir connected to the exit port/exhaust pipe of a hydrogen-fueled power source, such as a fuel cell, a turbine generator or an ICE).

Movement of material inside the fueling system may occur by: gravity flow, mechanical pumping (sometimes assisted by gravity), buoyant ascent (e.g., bubbles of hydrogen rising through a water-bearing liquid, see FIGS. 1(b) and 2(b)), and liquid/vapor-state diffusion/counter-diffusion (induced by gradients in the chemical potentials of two or more chemical components).

Internal, proximal, or distant sources of heat for the fueling system could be, for example but not limited to, one or more resistance heaters 214, or the “waste heat” given off by one or more hydrogen-fueled power sources (e.g., a fuel cell, a turbine generator, an ICE, etc.—not shown).

The hydrogen fueling system may comprise at least one fuel compartment 100 that is partially filled with one or more hydrogen gas-producing solid materials (fresh fuel) and a water-bearing liquid. The compartment is connected to a hydrogen-fueled power source, e.g., a fuel cell or an ICE (not shown), in a way that permits flow/diffusion of hydrogen gas from the compartment 100 to the power source, flow of liquid water and/or flow/diffusion of water vapor from the power source to the compartment 100, and flow of heat from the power source to the compartment 100. A substantial amount of the exchange of water and hydrogen between the power source and the compartment may occur by counterflow of liquid water and gaseous hydrogen, and by counter-diffusion of water vapor and gaseous hydrogen, through the conduit(s) (not shown) that connect(s) the compartment 100 with the power source (not shown). Counterflow and counter-diffusion of water and hydrogen results from consumption of hydrogen by the power source, and chemical reaction of water with fresh fuel. Optionally, heat produced by a heat source inside or outside the compartment may be used to induce chemical reaction of water with the fresh fuel, which creates an initial, or replenished, inventory of hydrogen gas. Spent fuel 106 replaces fresh fuel 104 inside the compartment 100 as production of hydrogen gas proceeds.

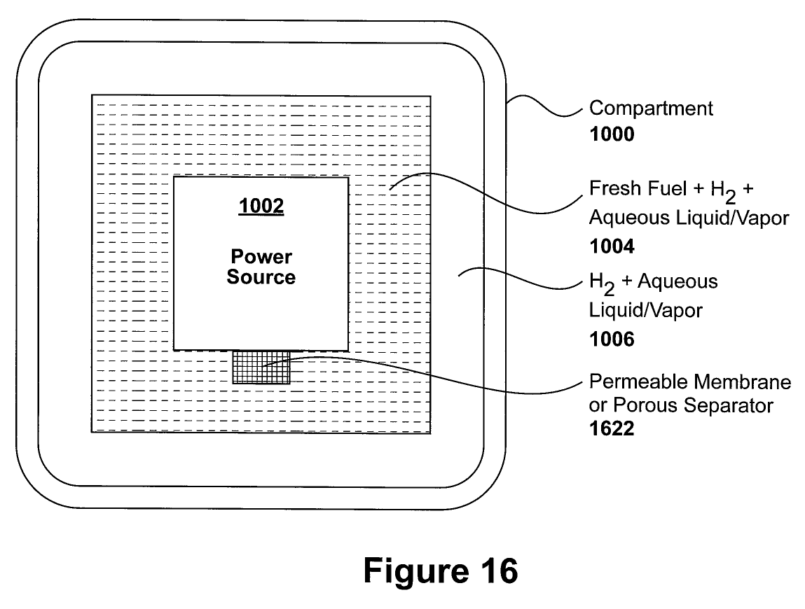

It is contemplated and within the scope of this disclosure that one or more of a permeable membrane (216 in FIGS. 2 and 3, and 1622 in FIG. 16) and/or a porous separator (216 in FIGS. 2 and 3, and 1622 in FIG. 16) may be used to prevent solid material in the compartment 100 from migrating out of that compartment (reservoir) into tubing 216 connected to the power source (FIGS. 2 and 3) or to the power source itself (FIG. 16).

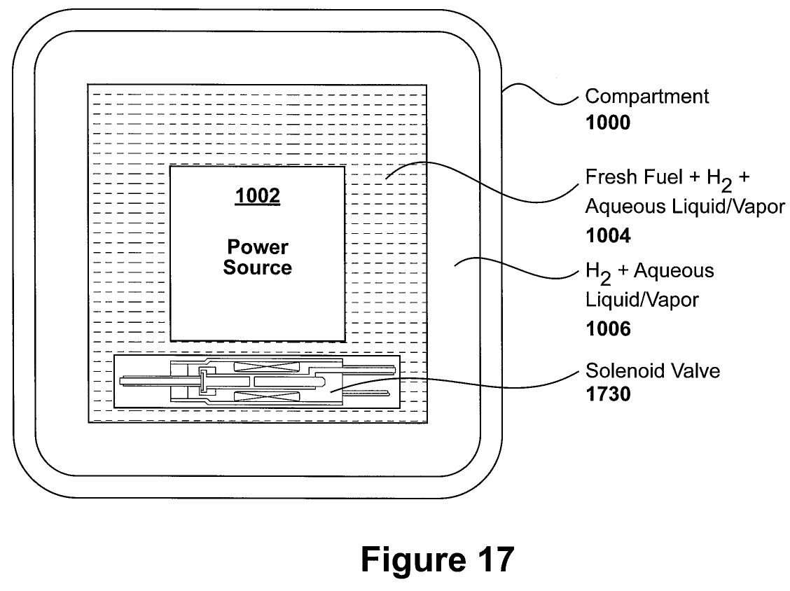

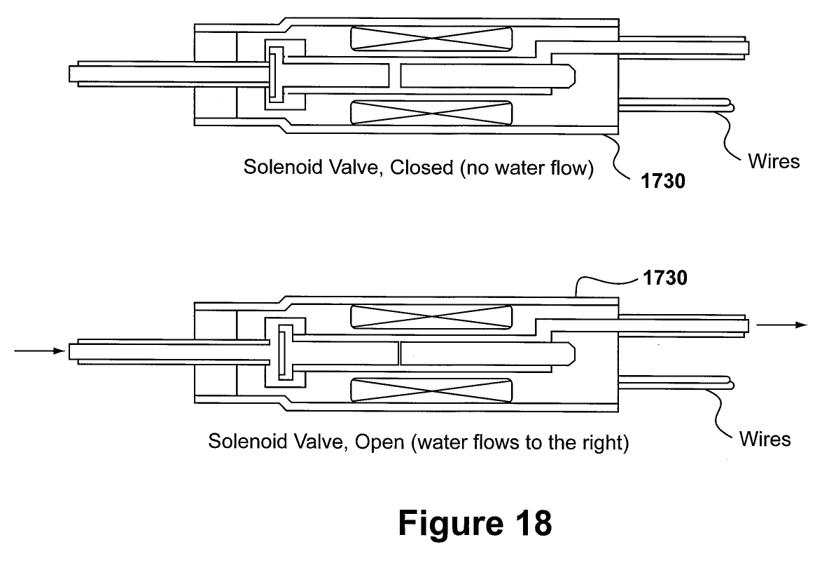

It is further contemplated and within the scope of this disclosure that the hydrogen fueling system may also include one or more valves (FIGS. 17 and 18) that may open or close in response to changes in temperature and/or gas pressure inside the fuel compartment(s) 100. When one or more of these valves are opened, liquid water, a water-bearing liquid, or water vapor, may be released into the compartment 100 from an internal or external source (not shown) of that liquid water, water-bearing liquid, or water vapor.

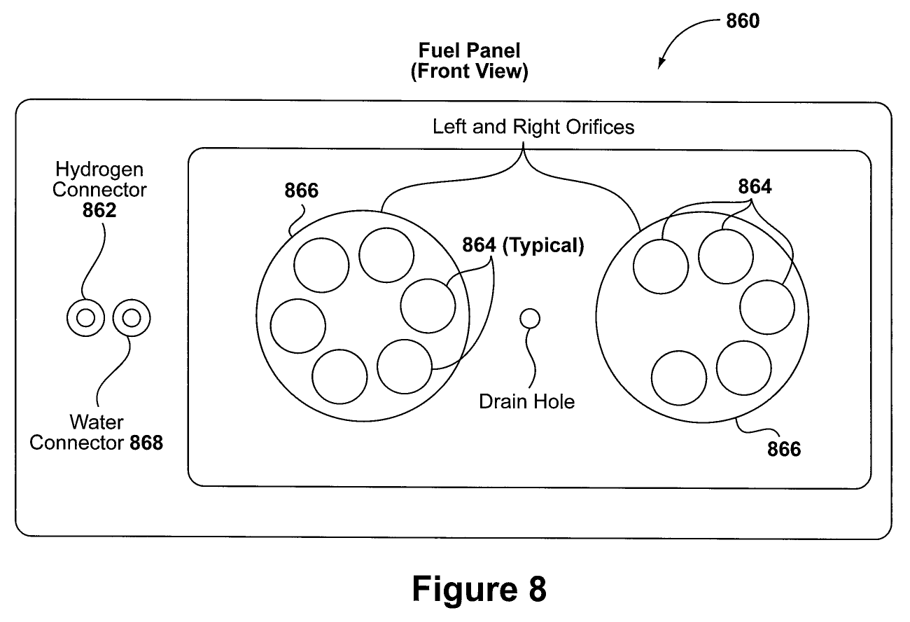

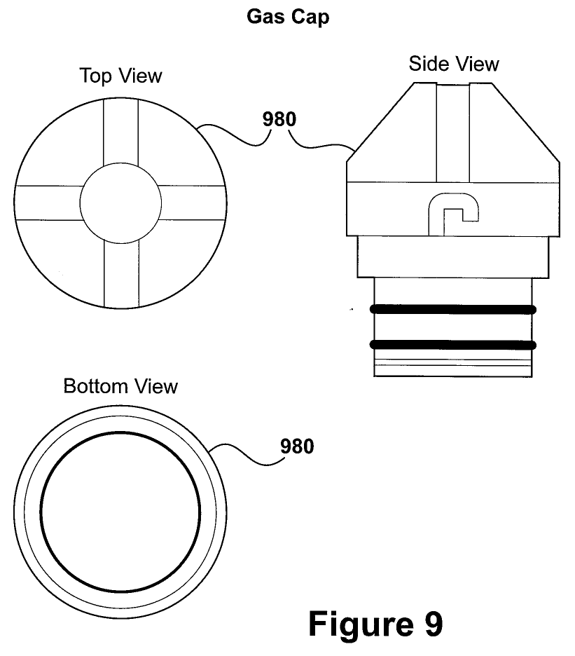

It is further contemplated and within the scope of this disclosure that the hydrogen fueling system may further comprise minor balance of plant (BOP) components, for example but not limited to: a fuel panel 860 (see FIG. 8), one or more hydrogen storage tanks (not shown), a pressure sensor (not shown), and various tubes (e.g., tubes 552 and 554 in FIG. 5) connecting together these parts of the fueling system. Each compartment 100 in the fuel tank 550 may be cylindrical, with two entry/exit ports (a lower entry/exit port 212 and an upper entry/exit port 216), and two flanking, circular resistance heaters 214. A set of tubes 552 and 554 may extend from the lower entry/exit ports 212 of the compartments 100 in the fuel tank 550 to the fuel panel 860 (e.g., one tube per compartment). A single tube, or series of interconnected tubes, may extend from an entry/exit port (a hydrogen connector) 862 (FIG. 8) on the fuel panel 860 to the hydrogen storage tank(s) (not shown). A second tube, or series of interconnected tubes, may extend from the hydrogen storage tank(s) (not shown) to a “common line” tube (not shown) near the fuel tank 550, which in turn is connected to tubes that extend from the upper entry/exit ports 216 of the compartments 100 comprising the fuel tank 550.

Gaseous hydrogen may be supplied to a hydrogen-fueled power source (not shown), such as a fuel cell, a turbine generator, an ICE, etc. The tubes 552 and 554 that extend from the fuel panel 860 to the lower entry/exit ports 212 of the compartments 100 in the fuel tank 550 (e.g., one tube per compartment) are conduits for: (i) fresh fuel—e.g., unreacted, hydrogen gas-producing solid and/or liquid material(s), plus or minus a slurrying/mobilizing liquid or gas; (ii) spent fuel; and possibly also (iii) a liquid and/or gas that increases the fluidity of the spent fuel, making it easier to remove it from each compartment 100 during refueling. The single tube, or series of interconnected tubes, that extends from the hydrogen connector 862 on the fuel panel 860 to the hydrogen storage tank(s) (not shown) is a conduit for hydrogen gas flowing either through the connector 862 to the hydrogen storage tank(s) (not shown), or from the hydrogen storage tank(s) (not shown) through the connector 862 to an external destination. Hydrogen may also flow in either direction through the series of tubes that connect the hydrogen storage tank(s) (not shown) with the upper entry/exit ports 216 of the compartments 100 comprising the fuel tank 550.

First-time fueling of this fueling system may be as follows: The fuel tank 550 and the hydrogen storage tank(s) (not shown) are empty. Therefore, the fueling system is prepared for operation as follows. (1) The fuel door (not shown) on the fuel panel 860 is opened to gain access to the material entry/exit ports 862 and 864 that are present there (one hydrogen connector 862 and 1-2 orifices 866 that house tubes through which gas, liquid, and/or fluidized granular solid material(s) flow into and out of the fueling system). (2) Optionally, oxygen or water present in the interior of the fueling system may be expelled by repeated purging with one or more of dry nitrogen, carbon dioxide, argon, or some other gas or liquid that is anhydrous or nearly so. (3) The 1-2 gas caps 980 covering the 1-2 orifices 866 on the fuel panel 860 are removed to allow liquid and/or granular solid, hydrogen gas-producing material(s) to be loaded into one or more of the compartments 100 in the fueling system. (4) Liquid and/or granular solid, hydrogen gas-producing material(s) is loaded into one or more compartments 100 of the fuel tank 550. For each compartment 100, this involves flow of the material(s) through the tube 552 or 554 that extends from the lower entry/exit port 212 in the compartment 100 to the fuel panel 860. If the material is a granular solid, it may be fluidized by either a pressurized gas (e.g., compressed hydrogen or dry nitrogen), and/or a pressurized liquid, e.g., mineral oil, an ionic liquid, etc. It is not necessary to load hydrogen gas-producing material(s) into each compartment, or to fill any or all compartments to capacity. The mass of hydrogen gas-producing material(s) loaded into an individual compartment 100 will generally depend partly on the desired amount of hydrogen gas to be produced in the compartment 100 “on demand” after fueling is completed. (5) After the liquid and/or granular solid, hydrogen gas-producing material(s) is loaded into one or more compartments 100 of the fuel tank 550, the 1-2 gas caps 980 covering the 1-2 orifices 866 on the fuel panel 860 are replaced. (6) Compressed hydrogen gas may be injected into the interior of the fueling system through the hydrogen connector 862 on the fuel panel 860.

The aforementioned fueling system may be refueled when the liquid and/or granular solid, hydrogen gas-producing material(s) is “reversible” to a satisfactory degree. Here “reversible” means that the hydrogen gas-producing material(s) (e.g., a metal hydride) can be rehydrogenated (regenerated) to a satisfactory degree in an acceptable period of time. In this circumstance, refueling involves pumping compressed hydrogen gas into the fueling system, through the hydrogen connector 862 on the fuel panel 860, until the hydrogen gas-producing material(s) is substantially or completely rehydrogenated.

The aforementioned fueling system may be refueled when the fueling system contains spent fuel (“spent fuel” may be defined herein as a poorly functioning liquid and/or granular solid, hydrogen gas-producing material(s)), that must be removed from one or more of the compartments to re-enable intra-compartment production of hydrogen gas after refueling. This expulsion may be accomplished in stepwise fashion as follows. (1) A hydrogen gas dispensing/receiving tube is connected to the hydrogen connector 862 on the fuel panel 860 to enable offloading of compressed hydrogen gas from the interior of the fueling system. This lowers hydrogen pressure in the fueling system to approximately one atmosphere (˜14.5 psia). (2) The 1-2 gas caps 980 on the fuel panel 860 is/are removed to allow spent fuel to be extracted from the fueling system. (3) One or more tubes, through which liquid and/or fluidized granular solid, hydrogen gas-producing material(s) flows, is connected to the orifice(s) 866 on the fuel panel 860. (4) Spent fuel is extracted from one or more compartments 100 of the fueling system.

For each compartment 100, this involves flow of material—gas, liquid and/or solid(s)—through the tube 552 or 554 that connects the lower entry/exit port 212 in the compartment 100 to the fuel panel 860. The following steps may be taken for the various types of hydrogen gas-producing materials. (1) If the hydrogen gas-producing material is a liquid, most of it can be extracted from the compartment 100 by, first, injecting gas into the compartment 100 through its upper entry/exit port 216 (to create a positive gas headspace pressure in the compartment), and second, by pumping the liquid out of the compartment 100 through its lower entry/exit port 212, using the tube 552 or 554 that connects the port 212 to the fuel panel 860. Optionally, a negative pressure can be applied to the anterior (fuel panel) end of the tube through which the spent fuel flows, thereby creating a “sucking force” on the liquid that makes it flow faster. (2) If the hydrogen gas-producing material is a slurried granular solid (e.g., a metal hydride), it would be removed from one or more compartments 100 of the fueling system in a manner similar to that discussed hereinabove for a hydrogen gas-producing liquid.

However, the slurry may be too thick (viscous) to readily flow out of the compartment, and/or it may contain aggregated masses of solid material (“clumps” or “chunks” of granular, reacted, or residual unreacted, hydrogen gas-producing solid material) that are too large to flow up the tube 552 or 554 connecting the lower entry/exit port 212 in the compartment 100 to the fuel panel 860. In the former circumstance, injecting a low-viscosity fluid into the compartment 100 through the tube 552 or 554 will probably suffice to achieve the desired extent of overall viscosity reduction. In the latter situation, repeated rapid injections and partial extractions of pressurized liquid (e.g., an ionic liquid), which will induce much roiling and swirling of material inside the compartment 100, will probably achieve the desired result—e.g., the disintegration of the aggregated masses of solid material into “chunks” that are small enough to pass through the tube 552 or 554 connecting the lower entry/exit port 212 in the compartment 100 to the fuel panel 860. (3) If the hydrogen gas-producing material is an unslurried granular solid, then the interior of the compartment 100 may be pressurized with gas as discussed in step 1 hereinabove, but in this circumstance gas pressure is allowed to build up to the point that, when pressure is suddenly reduced at a location beyond the anterior end of the tube 552 or 554 (outside of the fueling system), gas will flow rapidly up the tube 552 or 554, carrying mobilized grains of spent fuel along with it. These steps may need to be repeated several times to achieve a satisfactory “flushing” of the interior of the compartment 100.

Creation of hydrogen gas inside the multi-compartment fueling system after initial fueling or refueling may be as follows: When the pressure of the hydrogen gas inside the fueling system drops to a threshold level (which for a motor vehicle might be 50-200 psi), an electronic signal may be sent from the pressure sensor (not shown) to an external, electronic monitoring/controlling device (e.g., a microprocessor or computer onboard a motor vehicle) (not shown) indicating a need to increase the mass of hydrogen gas stored inside the fueling system. This event may trigger the following actions. (1) The electronic monitoring/controlling device (not shown) selects one of the compartments 100 that contains fresh fuel. (2) The two flanking heaters 214 on that compartment 100 are energized to raise the temperature of the fresh fuel 104 contained therein. (3) Heat is applied to the fresh fuel 104 until the desired mass of hydrogen gas 110 is created. The amount of produced hydrogen gas 110 may be either significantly less than, or essentially equal to, the entire inventory of chemically and structurally bound (adsorbed or absorbed) hydrogen in the compartment 100. If only part of that inventory is produced, the contents of the compartment 100 can be reheated at a later time to produce more hydrogen, again using the flanking heaters 214 to do the necessary heating. (4) Optionally, steps 1-3 may be repeated to create additional hydrogen gas inside the compartment 100 of the fueling system.

It is also contemplated and within the scope of this disclosure that the hydrogen fueling system may further comprise minor BOP components, for example but not limited to: a fuel panel 860, one or more hydrogen storage tanks (not shown), a pressure sensor (not shown), one or more water storage tanks (not shown), one or two water pumps (not shown), one or two small water reservoirs (not shown), two or more water valves (one valve per compartment in the fuel tank, and optionally a water valve on the upstream end of each water storage tank) (not shown), and various tubes (e.g., tubes 552 and 554 shown in FIG. 5) connecting these parts of the fueling system. Each compartment in the fuel tank 550 may be cylindrical, with a lower entry/exit port 212, an upper entry/exit port 216; and two flanking, circular resistance heaters 214. A first set of tubes 552 and 554 extend from the lower entry/exit ports 212 of the compartments 100 in the fuel tank 550 to the fuel panel 860 (one tube per compartment). A single tube, or series of interconnected tubes, extends from an entry/exit port 862 (a hydrogen connector) on the fuel panel 860 to the hydrogen storage tank(s) (not shown). A second tube, or series of interconnected tubes, extends from the hydrogen storage tank(s) (not shown) to a “common line” tube (not shown) near the fuel tank 550, which in turn is connected to tubes that extend from the upper entry/exit ports 216 of the compartments 100 of the fuel tank 550. A third tube, or series of interconnected tubes (not shown), extends from an entry/exit port 868 (a water connector) on the fuel panel 860 to the upstream side of the water storage tank(s) (not shown). A fourth tube, or series of interconnected tubes (not shown), extends from the downstream side of the water storage tank(s) (not shown) to the upstream side of a water pump (not shown). A fifth tube, or series of interconnected tubes (not shown), extends from the downstream side of that water pump (not shown) to a small water reservoir (not shown), which is on the upstream side of two or more water valves (FIG. 18). Water flows from the small water reservoir (not shown) into, and through, the water valves (FIG. 18). A second set of tubes extend from the downstream side of the water valves (FIG. 18) to the lower entry/exit ports 212 of the compartments 100 in the fuel tank 550 (one tube per compartment).

Optionally, there is a second water pump, (not shown) one or more additional water valves (not shown), and associated tubing (not shown), that connect the upstream side of the water storage tank(s) (not shown) to a water reservoir (not shown) on the downstream side of a hydrogen-fueled power source—such as a fuel cell, a turbine generator, or an ICE (not shown), which produces water as a byproduct of power production.

The aforementioned fueling systems may supply gaseous hydrogen to a hydrogen-fueled power source (not shown). Optionally, water produced by the power source (not shown) may be recovered, collected in a reservoir (not shown), and pumped into the water storage tank(s) (not shown) in the fueling system using the second water pump (not shown) discussed hereinabove. The tubes that extend from the fuel panel 860 to the lower entry/exit ports 212 of the compartments 100 of the fuel tank 550 (one tube per compartment) are conduits for: (i) fresh fuel—e.g., unreacted, hydrogen gas-producing solid and/or liquid material(s), plus or minus a slurrying/mobilizing liquid or gas; (ii) spent fuel; and possibly also (iii) a liquid and/or gas that increases the fluidity of the spent fuel, making it easier to remove it from each compartment. The single tube, or series of interconnected tubes, that extends from a hydrogen connector 862 on the fuel panel 860 to the hydrogen storage tank(s) (not shown) is a conduit for hydrogen gas flowing either through the hydrogen connector 862 to the hydrogen storage tank(s) (not shown) or from the hydrogen storage tank(s) (not shown) through the hydrogen connector 862 to an external destination. Hydrogen may also flow in either direction through the series of tubes that connect the hydrogen storage tank(s) (not shown) with the upper entry/exit ports 216 of the compartments 100 in the fuel tank 550. The single tube, or series of interconnected tubes, that extends from a water connector 868 on the fuel panel 860 to the water storage tank(s) (not shown) is a conduit for water, or a water-rich liquid, or hydrogen gas, that flows either through the water connector 868 to the water storage tank(s) (not shown), or from the water storage tank(s) (not shown) through the water connector 868. The tubes, water pump, and water valves that connect the downstream end of the water storage tank(s) (all not shown) with the lower entry/exit ports 212 of the compartments 100 in the fuel tank are conduits for water, or a water-rich liquid, flowing unidirectionally toward the fuel tank 550.

First-time fueling of the aforementioned fueling system may be as follows: The fuel, water, and hydrogen tank(s) are all empty. Therefore, the fueling system is prepared for operation as follows. (1) The fuel door (not shown) on the fuel panel 860 is opened to gain access to the material entry/exit ports 862, 864 and 868 that are present there (one hydrogen connector 862, one water connector 868, and 1-2 orifices 866 that house tubes (e.g., 864) through which gas, liquid, and/or fluidized granular solid material(s) may flow into and out of the fueling system). (2) Optionally, oxygen or water present in the interior of the fueling system is expelled by repeated purging with one or more of dry nitrogen, carbon dioxide, argon, or some other gas or liquid that is anhydrous or nearly so. (3) The 1-2 gas caps 980 covering the 1-2 orifices 866 on the fuel panel 860 are removed to allow granular solid, hydrogen gas-producing material(s) to be loaded into one or more compartments 100 of the fueling system (not shown). (4) Granular solid, hydrogen gas-producing material(s) may be loaded into one or more compartments 100 of the fuel tank 550. For each compartment 100, this involves flow of the material(s) through the tube 552 or 554 that extends from the lower entry/exit port 212 in the compartment 100 to the fuel panel 860. The material(s) may be fluidized by either a pressurized gas (e.g., compressed hydrogen or dry nitrogen), or a pressurized liquid (e.g., high-purity water, a water-bearing liquid, mineral oil, an ionic liquid, etc.). It is not necessary to load granular solid, hydrogen gas-producing material(s) into each compartment, or to fill any or all compartments to capacity. The mass of hydrogen gas-producing material(s) loaded into an individual compartment will generally depend on two factors: the desired amount of hydrogen gas to be produced in the compartment “on demand” after fueling is completed, and the change in volume of the granular solid, hydrogen gas-producing material(s) that occurs when hydrogen gas is formed in the compartment. (5) If the granular solid, hydrogen gas-producing material(s) forms hydrogen by reaction with either water or a water-bearing liquid, then the volume of granular solid spent fuel produced by this reaction is likely to be greater than the volume of the granular solid, hydrogen gas-producing material(s) that is consumed. To prevent the produced granular solid spent fuel from drying out and agglomerating (caking, clumping, etc.) in the compartment 100, it is preferable to have some extra liquid water, or water-bearing liquid, present in the compartment 100 after creation of hydrogen gas is complete (as more fully described hereinbelow). Thus, there must be sufficient “headspace” in the compartment 100 to accommodate this liquid water, or water-bearing liquid. Finally, to ensure that a compartment 100 does not suffer freeze damage during cold weather, the hydrogen entry/exit tube extending into the upper part of the compartment 100 from the upper entry/exit port 216 should be designed and positioned in a way that ensures retention of a small mass of hydrogen gas in the uppermost extremity of the compartment 100, should the amount of liquid water, or water-bearing liquid, present in the compartment 100 rise to the point that it touches the lower end of the hydrogen entry/exit tube at the upper entry/exit port 216. The idea is that, if the water, or water-bearing liquid in the compartment is converted partly or entirely to ice, the ice will expand into the available compartment “headspace” as freezing proceeds. (6) After granular solid, hydrogen gas-producing material(s) is loaded into one or more compartments in the fuel tank 550, the 1-2 gas caps 980 covering the 1-2 orifices 866 on the fuel panel 860 are replaced. (7) If production of hydrogen in the fuel tank 550 requires the presence of water or a water-bearing fluid, pressurized water, or water-bearing fluid, is pumped into the water tank(s) (not shown) through the tube, or series of interconnected tubes, that extends from the water storage tank(s) (not shown) to the water connector 868 on the fuel panel 860. (8) Compressed hydrogen gas may be injected into the hydrogen storage tank(s) through the hydrogen connector 862 on the fuel panel 860. In addition, a small mass of compressed hydrogen gas may be pumped into the water storage tank(s) (not shown) to create a small, gas-filled headspace into which ice can expand if it forms.

The aforementioned fueling system may be refueled when one or more compartments 100 of the fueling system contains spent fuel. Here “spent fuel” refers to a poorly functioning granular solid, hydrogen gas-producing material(s) that must be removed from one or more compartments to re-enable intra-compartment production of hydrogen gas after refueling. This expulsion is accomplished in stepwise fashion as follows. (1) A hydrogen gas dispensing/receiving tube is connected to the hydrogen connector on the fuel panel 860 to enable offloading of compressed hydrogen gas from the interior of the fueling system. This lowers hydrogen pressure in the fueling system to approximately one atmosphere (˜14.5 psia). (2) The 1-2 gas caps 980 on the fuel panel 860 is/are removed to allow spent fuel to be extracted from the fueling system. (3) One or more tubes, through which slurried granular solid, hydrogen gas-producing material(s) flows, is connected to the orifice(s) 866 on the fuel panel 860. (4) Slurried spent fuel is extracted from one or more compartments in the fueling system. For each compartment, this involves flow of spent fuel through the tube 552 or 554 that connects the lower entry/exit port 212 in the compartment 100 to the fuel panel 860. It may be possible to accomplish this by, first, injecting gas into the compartment 100 through its upper entry/exit port 216 (to create a positive gas headspace pressure in the compartment), and second, by pumping the slurry out of the compartment 100 through its lower entry/exit port 212, using the tube 552 or 554 that connects that port 212 to the fuel panel 860. Optionally, a negative pressure can be applied to the anterior end of the tube 552 or 554 through which the slurry flows, thereby creating a “sucking force” on the slurry that makes it flow faster. If the slurry is too thick (viscous) to readily flow out of the compartment 100, and/or if it contains aggregated masses of solid material (“clumps” or “chunks” of granular, reacted, or residual unreacted, hydrogen gas-producing solid material) that are too large to flow up the tube 552 or 554 connecting the compartment 100 to the fuel panel 860, then one or both of the following remedial actions may be taken. In the former circumstance, injecting a low-viscosity fluid into the compartment 100 through the tube 552 or 554 will probably suffice to achieve the desired extent of overall viscosity reduction. In the latter situation, repeated rapid injections and partial extractions of pressurized liquid (e.g., water), which will induce much roiling and swirling of material inside the compartment, will probably achieve the desired result—e.g., the disintegration of the aggregated masses of solid material into “chunks” that are small enough to pass through the tube 552 or 554 connecting the lower entry/exit port 212 in the compartment 100 to the fuel panel 860.

Creation of hydrogen gas inside the multi-compartment fueling system after initial fueling or refueling may be as follows: When the pressure of the hydrogen gas inside the fueling system drops to a threshold level (which for a motor vehicle would typically be 50-200 psi), an electronic signal is sent from the pressure sensor (not shown) to an external, electronic monitoring/controlling device (e.g., a microprocessor or computer onboard a motor vehicle) (not shown) indicating the need to increase the mass of hydrogen gas stored inside the fueling system. This event triggers the following actions. (1) The electronic monitoring/controlling device (not shown) selects one of the compartments 100 that contains fresh fuel 104. (2) The two flanking heaters 214 on that compartment 100 are energized to raise the temperature of the fresh fuel 104 contained therein. If liquid water, or a water-bearing liquid, is already present in the compartment 100 (as it might be if the fresh fuel was slurried with liquid water, or a water-bearing liquid, prior to being pumped into the fueling system), one or more hydrolysis reactions will be induced, forming hydrogen gas. (3) However, there may be no water, or water-bearing liquid, present in the compartment—or the mass of water, or water-bearing liquid, used to slurry the fresh fuel may be insufficient to produce the maximum possible amount of hydrogen gas by the operative hydrolysis reaction(s). If so, liquid water, or a water-bearing liquid, or additional water, or water-bearing liquid, flowing from an external source (not shown), must be injected into the compartment 100 to react away the existing/remaining hydrogen gas-producing solid material(s). In this circumstance, the necessary actions may be as follows. (i) The two side heaters 214 on the compartment 100 are energized to raise the temperature of the enclosed fresh fuel 104, or mixture of fresh fuel 104 and spent fuel 106. (ii) A heat sheath (not shown) covering the water-delivery tube (the tube in fluid communication with the lower entry/exit port 212 of the compartment 100) is energized to heat the wall of the tube prior to entry of flowing liquid water (or water-bearing liquid). (iii) The water valve (FIG. 18) on the upstream end of the water-delivery tube is opened, thereby enabling ingress of liquid water, or a water-bearing liquid. (iv) The upstream water pump (not shown) is energized, and pumping of liquid water (or a water-bearing liquid) into the water-delivery tube, commences. The temperature of the aqueous liquid rises as it flows through the water-delivery tube, due to prior heating of the wall of that tube. (v) Within a short period of time, heated aqueous liquid exits the water-delivery tube—flowing, first, into the distal end of the tube connecting the lower entry/exit port 212 of the compartment 100 to the fuel panel 860, and shortly thereafter, into the interior of the fuel compartment 100. (vi) The heated aqueous liquid is pumped into the fuel compartment 100 until either the desired mass of hydrogen gas is created, or until the maximum possible amount of stored hydrogen gas is produced.

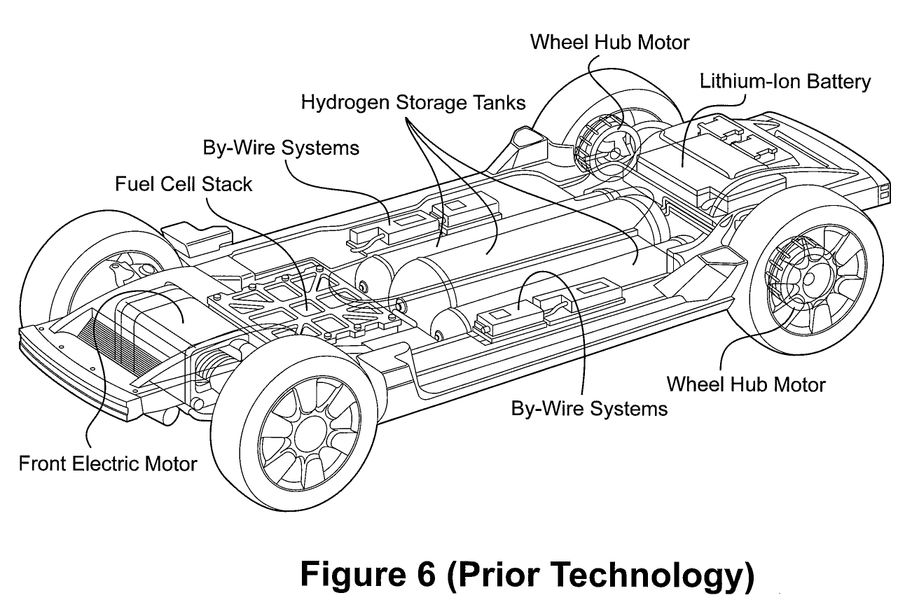

Referring to FIG. 6, depicted is a schematic diagram of a prior technology hydrogen fuel cell-powered vehicle chassis. General Motors has developed an electric drive, fuel cell-powered vehicle chassis that uses hydrogen gas stored in three cylindrical onboard tanks. General Motors has built operational prototype vehicles using this chassis. However, these prototype vehicles suffer from limited driving range and must use hydrogen gas stored in the onboard tanks at pressures up to 10,000 psi, which can be very dangerous in the event of a crash.

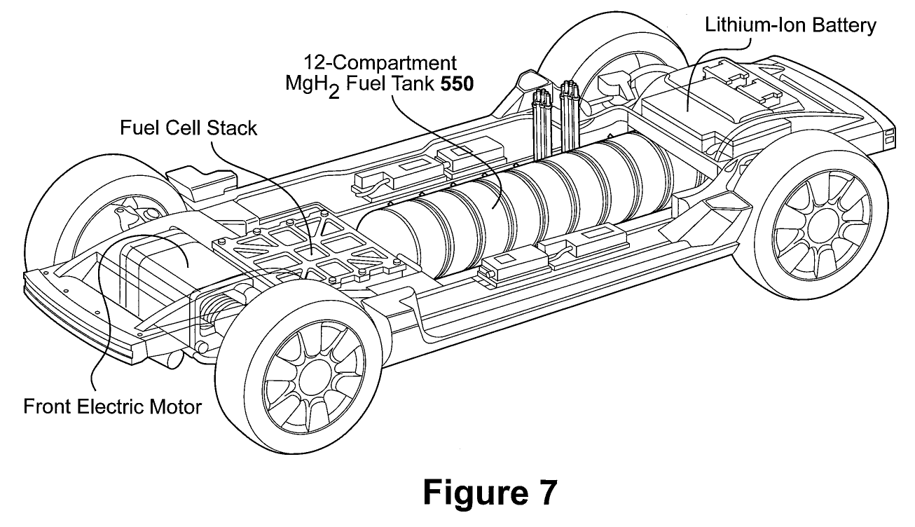

Referring to FIG. 7, depicted is a schematic diagram of a hydrogen fuel cell-powered vehicle chassis, according to a specific example embodiment of this disclosure. The General Motors hydrogen fuel cell-powered vehicle chassis may be easily adapted for use with a compartmentalized hydrogen fuel tank, according to the teachings of this disclosure. The high-pressure gaseous hydrogen storage tanks (FIG. 6) may be replaced with a multi-compartment hydrogen fuel tank 550 that supplies gaseous hydrogen on demand for operation of the vehicle. Operational range is greatly extended and crash safety is greatly improved.

The compartmentalized hydrogen fuel tank 550 (FIG. 5) can be easily adapted for use in any standard production vehicle that uses gaseous hydrogen as fuel. The Toyota Prius, Honda hybrid, BMW 7 series, etc., can use and/or can easily be adapted to use gaseous hydrogen as a fuel. The gaseous hydrogen may be supplied upon demand by the compartmentalized hydrogen fuel tank 550, according to the teachings of this disclosure.

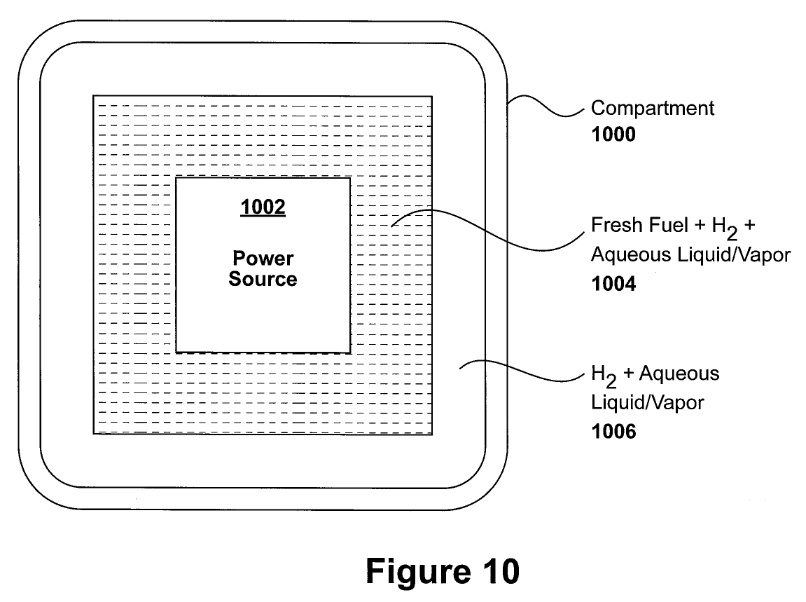

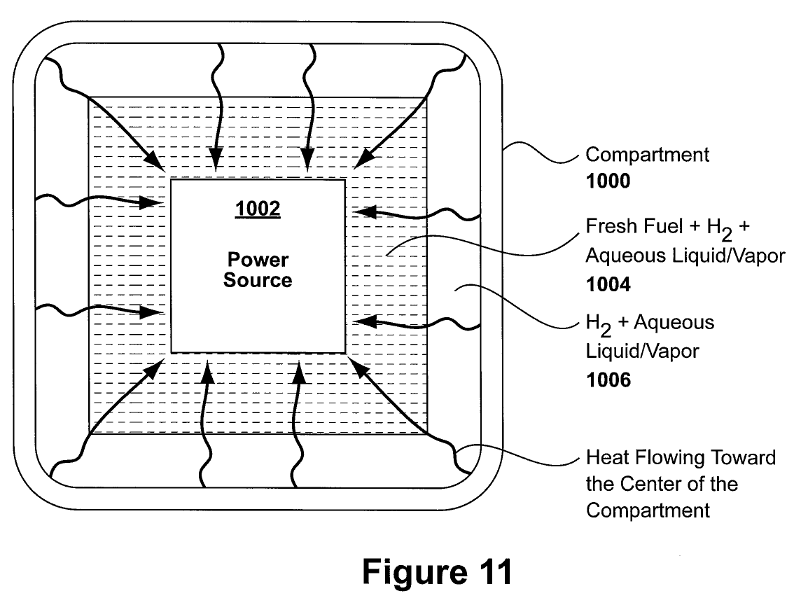

It is contemplated and within the scope of this disclosure that the single compartment 100, depicted in FIGS. 1 and 2, may be adapted to allow a power source, e.g., a micro-power fuel cell, a micro-turbine, etc., to be utilized in, for example but not limited to, applications normally requiring battery operation thereof. Referring now to FIGS. 10 and 11, depicted are schematic diagrams for a first-time use of a power source after initial fueling, or refueling, of a one-compartment, hydrogen-fueled power system, according to specific example embodiments of this disclosure. Initially, the power source 1002 is turned off; the surrounding fuel compartment 1000 contains fresh fuel and a small amount of liquid water or water-bearing liquid (“aqueous liquid”) and water vapor, but little or no spent fuel and hydrogen gas; and either “residual heat” (not shown) is flowing away from the power source 1002, or little or no heat is flowing into, or out of, the interior of the compartment 1000. Next, a small mass of hydrogen may be loaded into, and sealed within, the interior of the compartment 1000 (FIG. 10). This hydrogen gas remains inside the compartment 1000, available to the power source 1002 for “start-up” in creating electrical or mechanical energy.

As an alternative, initially, the power source 1002 is turned off; the surrounding fuel compartment 1000 contains fresh fuel and a small amount of aqueous liquid/vapor, but little or no spent fuel and hydrogen gas; and heat flows toward the center of the compartment 1000 from either an internal heat source (not shown) that surrounds the fresh fuel and aqueous liquid/vapor, or an external heat source (not shown). With increasing time, the temperature of the fresh fuel and aqueous liquid/vapor rises sufficiently to induce the reaction of fresh fuel+aqueous liquid/vapor→spent fuel+hydrogen gas (FIG. 11). The produced hydrogen gas remains inside the compartment, available to the power source 1002 for “start-up” in creating electrical or mechanical energy.

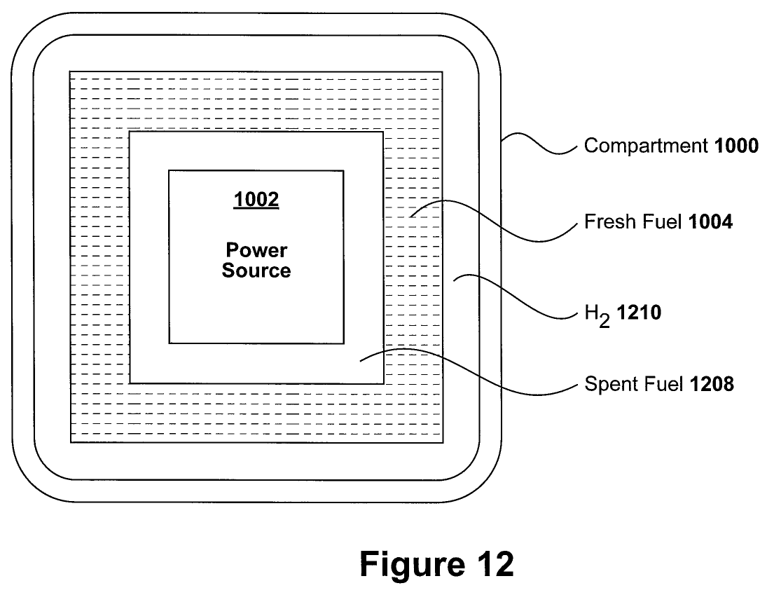

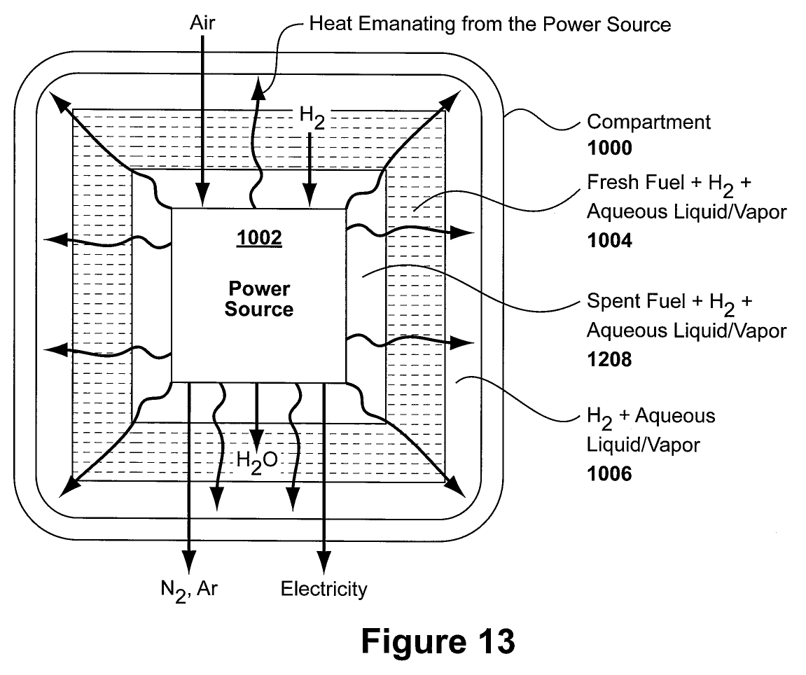

Referring now to FIGS. 12 and 13, depicted are schematic diagrams for a restart of the power source, according to specific example embodiments of this disclosure, after some (but not all) of the fresh fuel and aqueous liquid/vapor has been converted to spent fuel and hydrogen gas by the reaction fresh fuel+aqueous liquid/vapor→spent fuel+hydrogen gas. Initially (FIG. 12), the power source 1002 is turned off; the surrounding fuel compartment 1000 contains fresh fuel 1004, spent fuel 1208, and “residual” hydrogen gas 1210, but little or no aqueous liquid/vapor; and either “residual heat” is flowing away from the power source (not shown) or little or no heat is flowing into, or out of, the interior of the compartment 1000. Next, the power source 1002 is turned on, which causes: (i) hydrogen gas 1210 to flow toward, and into, the power source 1002, (ii) liquid water and/or water vapor to flow out of the power source 1002 and into the compartment 1000, and (iii) heat to flow away from the power source 1002. With increasing time, the temperature of the fresh fuel 1004, and the intergranular aqueous liquid/vapor it contains, rises sufficiently to induce the reaction fresh fuel+aqueous liquid/vapor→spent fuel+hydrogen gas (FIG. 13). The produced hydrogen gas replaces hydrogen gas that previously resided in the compartment, which flowed into the power source after it was turned on.

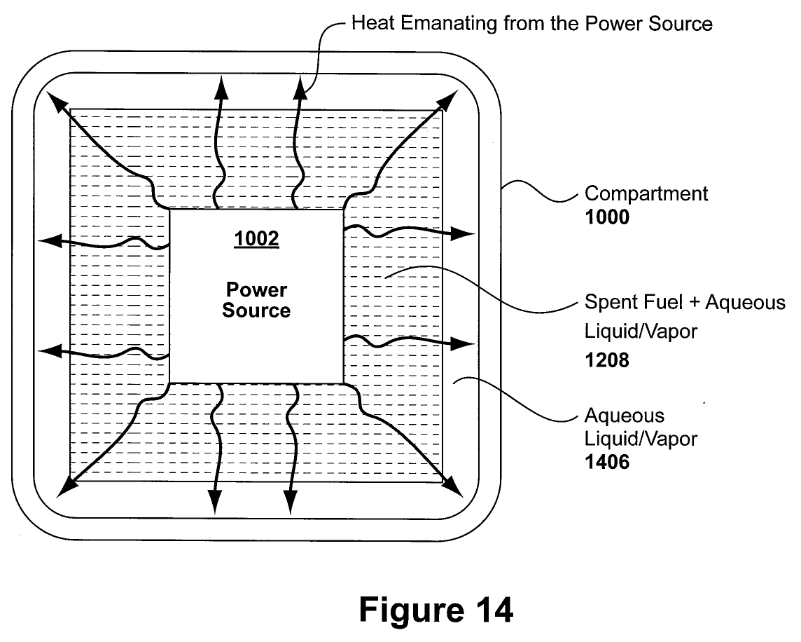

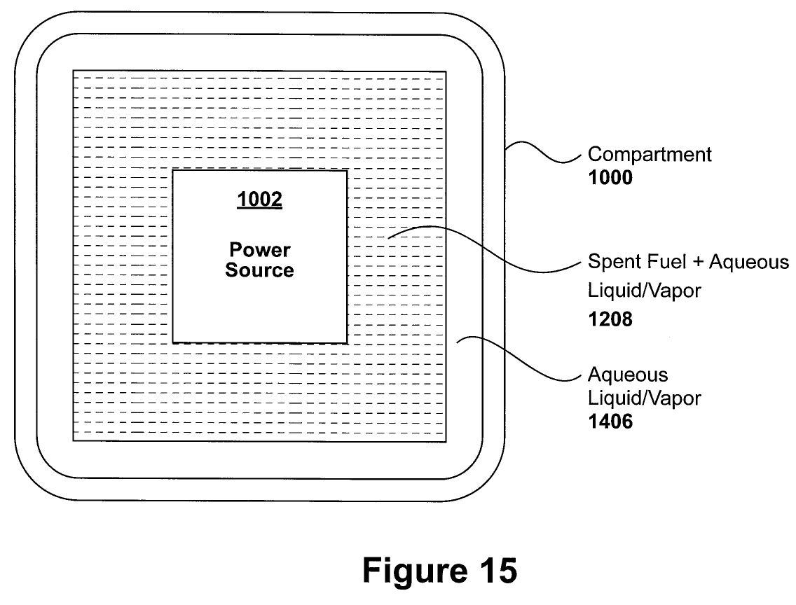

Referring to FIGS. 14 and 15, depicted are schematic diagrams of the one-compartment hydrogen fueled power system described hereinabove when fresh fuel runs out, according to specific example embodiments of this disclosure. FIGS. 14 and 15 represent: (i) the moment when fresh fuel runs out, and (ii) the time thereafter, leading up to refueling of the compartment 1000. For the purpose of the examples described hereinbelow, the latter interval is assumed to occur sometime after the temperature of the compartment 1000 and the contents contained therein have reached ambient temperature, so that net heat flow, into and out of the compartment 1000, is substantially zero.

Initially (FIG. 14), the power source 1002 is turned on; the surrounding fuel compartment 1000 contains spent fuel 1208 and a small amount of aqueous liquid/vapor 1406, but little or no fresh fuel and hydrogen gas; and heat is flowing away from the power source. The power source 1002 is no longer operating due to the exhaustion of the hydrogen gas that was present in the compartment 1000. With increasing time, the temperature of the compartment 1000 and the contents contained therein decrease to ambient temperature, whereupon heat stops flowing away from the interior of the compartment 1000 toward its exterior (FIG. 15). To allow the power source 1002 to resume operation, the spent fuel 1208 in the compartment 1000 may be replaced, either partially or entirely, by fresh fuel, and one of the two examples described hereinabove may be followed to create an “initial inventory” of hydrogen gas inside the compartment 1000 (see FIGS. 10 and 11 and related description thereof).

Referring to FIG. 16, depicted is a schematic diagram of a one-compartment, hydrogen-fueled power system further comprising a gas permeable membrane or gas porous separator, according to another specific example embodiment of this disclosure. The gas permeable membrane or gas porous separator substantially prevent solid material in the compartment 1000 from migrating out of the compartment 1000 and into the power source 1002.

Referring to FIGS. 17 and 18, depicted is a schematic diagram of a one-compartment, hydrogen-fueled power system having a solenoid valve, according to still another specific example embodiment of this disclosure. A solenoid valve 1730 is adapted to open and close (see FIG. 18) in response to changes in temperature and/or gas pressure inside the fuel compartment 1000. When the solenoid valve 1730 is open, fluid, e.g., liquid water, a water-bearing liquid, or water vapor, is released into the compartment 1000 from an internal or external source of that liquid water, water-bearing liquid, or water vapor (not shown). The amount of fluid introduced into the compartment 1000 will determine the amount of gaseous hydrogen generated therein.

Typically, the pressure of the enclosed gaseous hydrogen may be from about 50 psi to about 1000 psi. The gaseous hydrogen used in the micro-power source systems may be at pressures ranging from about one atmosphere to about two atmospheres.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An apparatus for generating gaseous hydrogen, comprising:
a compartment having a first port; and
hydrogen gas-producing material, the hydrogen gas-producing material being located inside of the compartment;
wherein the hydrogen gas-producing material releases gaseous hydrogen when a condition thereof is changed, and whereby the first port communicates the gaseous hydrogen outside of the compartment.

2. The apparatus according to claim 1, wherein the condition is reduction of pressure inside the compartment.

3. The apparatus according to claim 1, wherein the condition is adding heat to the hydrogen gas-producing material.

4. The apparatus according to claim 3, wherein the heat is from a source external to the compartment.

5. The apparatus according to claim 3, wherein the heat is from a source internal to the compartment.

6. The apparatus according to claim 1, wherein the hydrogen gas-producing material comprises a hydrogen gas-producing solid and a hydrogen gas-producing liquid.

7. The apparatus according to claim 6, wherein the hydrogen gas-producing solid is magnesium hydride (MgH₂), and the hydrogen gas-producing liquid is water (H₂O).

8. The apparatus according to claim 7, wherein the magnesium hydride (MgH₂) and the water (H₂O) are chemically combined to produce gaseous hydrogen and magnesium hydroxide (Mg(OH)₂).

9. The apparatus according to claim 8, wherein heat is added to the magnesium hydride (MgH₂) and the water (H₂O) during chemical combination thereof for controlling an amount of gaseous hydrogen produced.

10. The apparatus according to claim 1, further comprising a second port for loading fresh hydrogen gas-producing material into the compartment and removing spent hydrogen gas-producing material from the compartment.

11. The apparatus according to claim 1, wherein the gaseous hydrogen is at a pressure from about 50 pounds per square inch to about 1000 pounds per square inch.

12. An apparatus for generating gaseous hydrogen, comprising:
a plurality of compartments, each of the plurality of compartments having a first port; and
hydrogen gas-producing material, wherein the hydrogen gas-producing material is located inside of the plurality of compartments;
wherein a portion of the hydrogen gas-producing material located in a respective one of the plurality of compartments releases gaseous hydrogen when a condition thereof is changed, and whereby the respective first port communicates the gaseous hydrogen outside of the respective one of the plurality of compartments.

13. The apparatus according to claim 12, wherein the condition is reduction of pressure inside the respective one of the plurality of compartments.

14. The apparatus according to claim 12, wherein the condition is adding heat to the portion of the hydrogen gas-producing material in the respective one of the plurality of compartments.

15. The apparatus according to claim 14, wherein the heat is from a source external to the respective one of the plurality of compartments.

16. The apparatus according to claim 14, wherein the heat is from a source internal to the respective one of the plurality of compartments.

17. The apparatus according to claim 12, wherein the hydrogen gas-producing material comprises a hydrogen gas-producing solid and a hydrogen gas-producing liquid.

18. The apparatus according to claim 17, wherein the hydrogen gas-producing solid is magnesium hydride (MgH₂), and the hydrogen gas-producing liquid is water (H₂O).

19. The apparatus according to claim 18, wherein the magnesium hydride (MgH₂) and the water (H₂O) are chemically combined to produce gaseous hydrogen and magnesium hydroxide (Mg(OH)₂).

20. The apparatus according to claim 19, wherein heat is added to the magnesium hydride (MgH₂) and the water (H₂O) during chemical combination thereof for controlling an amount of gaseous hydrogen produced.

21. The apparatus according to claim 12, further comprising a second port on each of the plurality of compartments for loading fresh hydrogen gas-producing material into each one of the plurality of compartments and removing spent hydrogen gas-producing material from each one of the plurality of compartments.

22. The apparatus according to claim 12, further comprising a plurality of heaters, each of the plurality of heaters being in thermal communication with a respective one of the plurality of compartments, wherein the plurality of heaters are individually controllable to supply heat to the respective ones of the plurality of compartments, whereby the portion of the hydrogen gas-producing material located in the heated respective one of the plurality of compartments releases gaseous hydrogen.

23. The apparatus according to claim 12, wherein the first ports of the plurality of compartments are in gaseous communication.

24. The apparatus according to claim 21 wherein the second ports of the plurality of compartments are isolated from one another.

25. The apparatus according to claim 12, wherein the plurality of chambers have walls comprised of a plurality of layers.

26. The apparatus according to claim 25, wherein the plurality of layers comprise one or more types of polymers.

27. The apparatus according to claim 25, wherein the plurality of layers comprise one or more types of metals.

28. The apparatus according to claim 25, wherein the plurality of layers comprise one or more types of metal alloys.

29. The apparatus according to claim 25, wherein the plurality of layers comprise at least one type of polymer interleaved with at least one type of metal.

30. The apparatus according to claim 25, wherein the plurality of layers comprise at least one type of polymer interleaved with at least one type of metal alloy.

31. The apparatus according to claim 25, wherein the plurality of layers are interleaved and selected from the group consisting of polymers, metals and metal alloys.

32. The apparatus according to claim 12, wherein the plurality of compartments are arranged as a hydrogen fuel tank.

33. The apparatus according to claim 21, further comprising:
a fuel panel having
a first panel port in gaseous communication with the first ports on the plurality of compartments,
a plurality of second panel ports, wherein each of the plurality of second panel ports is in fluid communications with respective ones of the second ports on the plurality of compartments,
whereby gaseous hydrogen is injected into or withdrawn from the plurality of compartments through the first panel port,
whereby the fresh hydrogen gas-producing material is loaded into individual ones of the plurality of compartments through respective ones of the plurality of second panel ports, and
whereby the spent hydrogen gas-producing material is removed from the individual ones of the plurality of compartments through the respective ones of the plurality of second panel ports.

34. The apparatus according to claim 32, wherein the hydrogen fuel tank is adapted to supply gaseous hydrogen to a power source.

35. The apparatus according to claim 34, wherein the power source is a fuel cell that generates electricity from the gaseous hydrogen from the hydrogen fuel tank.

36. The apparatus according to claim 34, wherein the power source is a hydrogen gas burning turbine that generates mechanical rotational power by burning the gaseous hydrogen from the hydrogen fuel tank.

37. The apparatus according to claim 34, wherein the power source is an internal combustion engine that generates mechanical power by igniting in each cylinder the gaseous hydrogen from the hydrogen fuel tank.

38. The apparatus according to claim 34, wherein the hydrogen fuel tank and power source are used to provide locomotion for a vehicle.

39. The apparatus according to claim 38, wherein the vehicle is selected from the group consisting of automobile, truck, bus, motorcycle, boat, airplane and train.

40. The apparatus according to claim 12, wherein the gaseous hydrogen is at a pressure from about 50 pounds per square inch to about 1000 pounds per square inch.

41. A power system fueled with hydrogen, said system comprising:
a compartment;
a power source fueled by gaseous hydrogen, the power source being located inside of the compartment; and
hydrogen gas-producing material, the hydrogen gas-producing material being located inside of the compartment;
wherein the hydrogen gas-producing material releases gaseous hydrogen to the power source within the compartment when a condition thereof is changed.

42. The power system according to claim 41, wherein the condition is reduction of pressure inside the compartment.

43. The power system according to claim 41, wherein the condition is adding heat to the hydrogen gas-producing material.

44. The power system according to claim 43, wherein the heat is from a source external to the compartment.

45. The power system according to claim 43, wherein the heat is from a source internal to the compartment.

46. The power system according to claim 41, wherein the hydrogen gas-producing material comprises a hydrogen gas-producing solid and a hydrogen gas-producing liquid.

47. The power system according to claim 46, wherein the hydrogen gas-producing solid is magnesium hydride (MgH₂), and the hydrogen gas-producing liquid is water (H₂O).

48. The power system according to claim 47, wherein the magnesium hydride (MgH₂) and the water (H₂O) are chemically combined with heat to produce gaseous hydrogen and magnesium hydroxide (Mg(OH)₂).

49. The power system according to claim 48, wherein heat is added to the magnesium hydride (MgH₂) and the water (H₂O) during chemical combination thereof for controlling an amount of gaseous hydrogen produced.

50. The power system according to claim 41, further comprising a gas permeable membrane between the hydrogen gas-producing material and the power source.

51. The power system according to claim 41, further comprising a gas porous separator between the hydrogen gas-producing material and the power source.

52. The power system according to claim 41, further comprising a solenoid valve for controlling an amount of fluid introduced into the compartment.

53. The power system according to claim 52, wherein the solenoid valve is controlled by pressure in the compartment.

54. The power system according to claim 52, wherein the solenoid valve is controlled by temperature in the compartment.

55. The power system according to claim 52, wherein the fluid is from an external source.

56. The power system according to claim 52, wherein the fluid is from an internal source.

57. The power system according to claim 52, wherein the fluid is selected from the group consisting of liquid water, a water-bearing liquid, and water vapor.

58. The apparatus according to claim 41, wherein the gaseous hydrogen is at a pressure from about 50 pounds per square inch to about 1000 pounds per square inch.

59. The apparatus according to claim 41, wherein the gaseous hydrogen is at a pressure from about one atmosphere to about two atmospheres.
